(19) United States
(12) Patent Application Publication
(10) Pub. No.: US 2023/0139940 A1
(43) Pub. Date: May 4, 2023

(54) RETRACTABLE DRILL CHUCK SYSTEM

(71) Applicant: SOTERIA INDUSTRIES, INC., Calgary (CA)

(72) Inventors: Andrew Spencer Loblaw, Calgary (CA); Christian David Parker, Cochrane (CA); Ian King Yeung Lo, Calgary (CA); Mason Lee Ledinski, Calgary (CA); Ryan Justin Ma, Calgary (CA); Warren Adam Shier, Calgary (CA)

(21) Appl. No.: 18/051,382

(22) Filed: Oct. 31, 2022

Related U.S. Application Data
(60) Provisional application No. 63/274,320, filed on Nov. 1, 2021.

(51) Int. Cl. B23B 49/00

(52) U.S. Cl. CPC B23B 49/00; B23B 2260/0482

(57) ABSTRACT

A retractable drill chuck system that is capable of being attached to a drill and drill bit; it can detect the initial breakthrough of the drill bit in a material and is capable of retracting the drill bit right as the drill bit breaks through the material; it has torque, force, and acceleration sensors to detect the breakthrough event of a drill bit; it also has an electromechanical mechanism to retract the drill bit from the material once the breakthrough event has been detected by the system; the retraction mechanism has a permanent magnet holding solenoid that, when activated, releases stored mechanical energy to allow the drill bit to be retracted.

### CROSS-REFERENCE TO RELATED APPLICATIONS

The present application claims priority to and the benefit of 63/274,320, filed 1 Nov. 2021 and titled RETRACTABLE DRILL CHUCK SYSTEM, which is incorporated by reference herein in its entirety.

### BACKGROUND

The embodiments relate to a drill chuck system that is capable of detecting the drilling breakthrough of a drill bit and retracting the drill bit before the drill bit breaks through the material that is being drilled into.

### BRIEF SUMMARY

A retractable drill chuck system is disclosed that is capable of being attached to a drill and drill bit. The present disclosure can detect the initial breakthrough of the drill bit in a material and is capable of retracting the drill bit right as the drill bit breaks through the material. The system includes torque, force, and acceleration sensors to detect the breakthrough event of a drill bit. The system includes an electromechanical mechanism to retract the drill bit from the material once the breakthrough event has been detected by the system. The retraction mechanism includes a permanent magnet holding solenoid that, when activated, releases stored mechanical energy to allow the drill bit to be retracted.

Additional aspects of the drill chuck system includes that it is capable of detecting a breakthrough event of a drill bit; the system including one or more reaction torque sensors wherein the fixed side is attached to the drill side of the device and wherein the floating side is attached to the drill bit side of the device, one or more reaction force sensors wherein the fixed side is attached to the drill side of the device and wherein the floating side is attached to the drill bit side of the device, one or more accelerometer(s) are offset from the center of the device, one or more batterie(s) are used to power the device, one or more controllers are used to read the force, torque and acceleration sensor(s) and determine the drill bit breakthrough event, a shaft mount to attach to a drill and/or rotating spindle, and a drill bit holder.

In any aspect or embodiment described herein, the drill chuck system comprises one or more permanent magnet holding solenoid are used in the retraction mechanism of the device, one or more set of linear bearing(s) and linear shaft(s) are used in the retraction mechanism of the device, one or more slide lock(s) are used to control the locking of the retraction mechanism, one or more pivot block(s) are used to control the locking of the retraction mechanism, one or more release pin(s) are used to lock the pivot block(s) in place, one or more armature(s) are used to attach to the permanent magnet holding solenoid(s) by means of magnetism, one or more preload spring(s) are used to apply force to the armature(s), one or more extension spring(s) are used to apply force to retract the drill bit, one or more capacitor(s) are used to activate the permanent magnet holding solenoid(s)

In any aspect or embodiment described herein, the drill chuck system comprises one controller used to determine the drill bit breakthrough event detection and control the retraction mechanism activation. In any aspect or embodiment described herein, the drill chuck system comprises one controller used to read the force, torque, and acceleration sensor(s), determine the drill bit breakthrough event, and control the retraction mechanism activation.

In any aspect or embodiment described herein, the drill chuck system may also include one or more gyroscopes used in the breakthrough event detection system. In any aspect or embodiment described herein, the drill chuck system comprises one or more gyroscopes used in the breakthrough event detection system in place of the accelerometer(s).

In any aspect or embodiment described herein, the drill chuck system comprises one or more electromagnet actuator and/or solenoid actuator used in place of the permanent magnet holding solenoid(s) and armature(s).

In any aspect or embodiment described herein, the drill chuck system comprises one or more bushings that are used in the retraction mechanism in place of the linear bearing(s).

The foregoing and other objects, features and advantages of the preferred retractable drill chuck system will be apparent from the following more particular description of a preferred embodiment of the invention, as illustrated in the accompanying drawings.

### BRIEF DESCRIPTION OF THE DRAWINGS

The present disclosure is illustrated by way of example and not limited in the accompanying figures in which like reference numerals indicate similar elements.

FIG. 1 is a perspective view of the retractable drill chuck system 100 mounted in a drill 110 with a drill bit 120 installed into chuck system.

FIG. 2 is a perspective view of the retractable drill chuck system 100 with a drill bit 120 installed into chuck system.

FIG. 3 is a perspective view of the front side of the retractable drill chuck system 100.

FIG. 4 is a perspective view of the backside of the retractable drill chuck system 100.

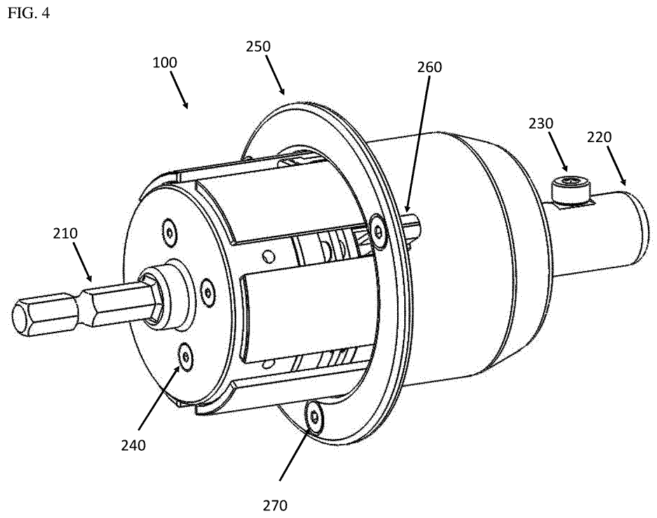

FIG. 5 is a perspective view of the backside of the retractable drill system 100 with the shaft mount 210, shaft mount screws 240, drill bit mount 220, drill bit locking screw 230 and drill bit mount mounting screws 280 expanded in the axially direction.

FIG. 6 is a side view of the reaction torque/force sensor 290 showing one side fixed 300 and torque and force applied to the other side that is floating 310.

FIG. 7 is a perspective view of a typical reaction torque/force sensor 290 using strain gauges 320 for the measurement of force and torque applied to a floating side 310 and one side of the sensor fixed 300.

FIG. 8 is a perspective view of the retractable drill chuck system 100 with the shaft mount 210, shaft mount screws 240, drill bit mount 220, drill bit mount mounting screws 280 and drill bit locking screw 230 hidden from the view along with the preload spring 350, permanent magnet holding solenoid 360, solenoid mount 340 solenoid mount mounting screws 370 and solenoid holding nut 390 expanded axially.

FIG. 9 is a perspective view of the retractable drill chuck system 100 with the shaft mount 210, shaft mount screws 240, drill bit mount 220, drill bit mount mounting screws 280 and drill bit locking screw 230, preload spring 350, permanent magnet holding solenoid 360, solenoid mount 340 solenoid mount mounting screws 370 and solenoid holding nut 390 hidden from the view along with the, reset ring 250, reset ring mounting screws 270, reset shafts 420 and armature 410 expanded axially. The reset arms 430 are shown expanded radially.

FIG. 10 is a perspective view of the retractable drill chuck system 100 with the shaft mount 210, shaft mount screws 240, drill bit mount 220, drill bit mount mounting screws 280 and drill bit locking screw 230, preload spring 350, permanent magnet holding solenoid 360, solenoid mount 340 solenoid mount mounting screws 370, solenoid holding nut 390, reset ring 250, reset ring mounting screws 270, reset shafts 420 and armature 410 hidden from the view along with the, reaction torque/force sensor 290, slide lock 440, slide lock mount screws 450, controller board mounting screws 460, controller board 700, cap mounting screws 470, cap 480, linear bearings 490, pivot block assembly 600, linear shafts 500, and armature 410 expanded axially.

FIG. 11 is a perspective view of the pivot block assembly 600 with the extension spring 610 and release pin 620 expanded axially along with the pivot blocks 640, extension spring locking screw 650 and pivot block pins 660 expanded radially.

FIG. 12 is a side section view showing the retractable drill chuck system 100 in the “Extended/Locked” position.

FIG. 13 is a block diagram of the controller board 700.

FIG. 14 is a side section view showing the retractable drill chuck system 100 in the “Extended/Unlocked” position.

FIG. 15 is a side section view showing the retractable drill chuck system 100 in the “Retracted/Unlocked” position.

FIG. 16 is a flowchart showing a method of operating a retractable drill chuck system according to an embodiment.

### DETAILED DESCRIPTION

Aspects of the disclosed embodiments will now be addressed with reference to the figures. Aspects in any one figure is equally applicable to any other figure unless otherwise indicated. Aspects illustrated in the figures are for purposes of supporting the disclosure and are not in any way intended on limiting the scope of the disclosed embodiments. Any sequence of numbering in the figures is for reference purposes only.

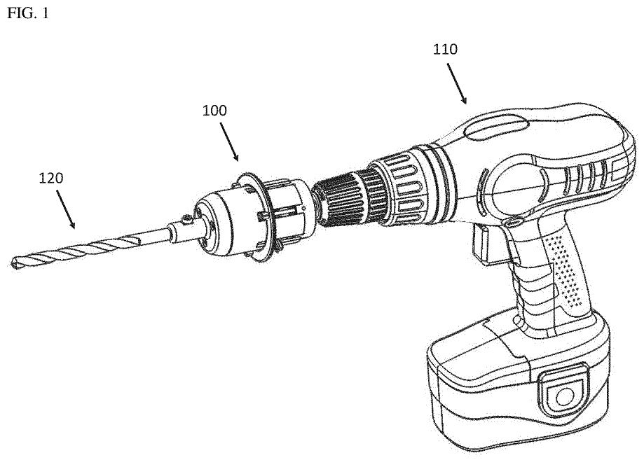

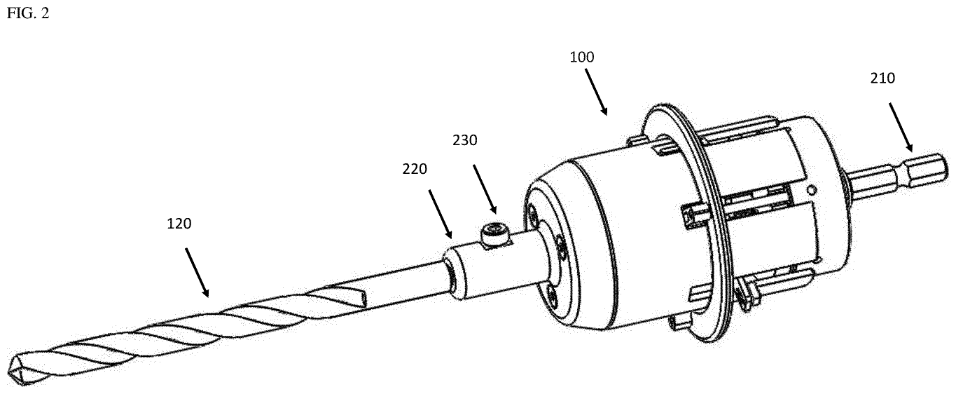

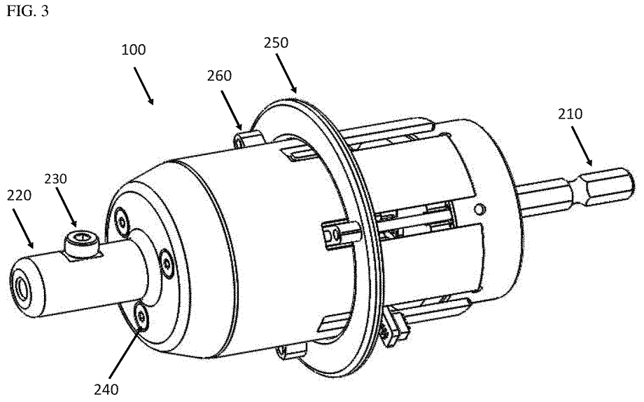

In the drawings FIG. 1 shows a retractable drill chuck system 100 mounted in a drill 110. The retractable drill chuck system 100 is attached to the drill 110 by means of a shaft mount 210, shown in FIG. 2. The drill bit 120 is mounted to the retractable drill chuck system 100 by means of the drill bit mount 220 and drill bit locking screw 230 as show in FIG. 3.

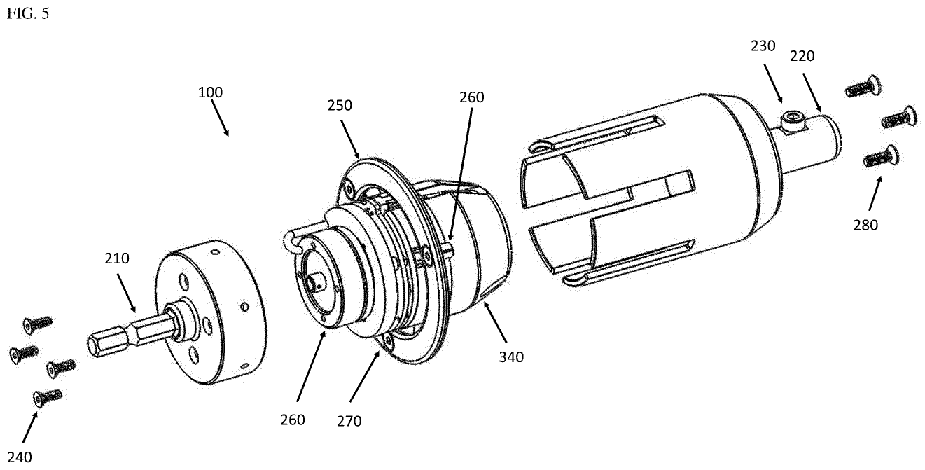

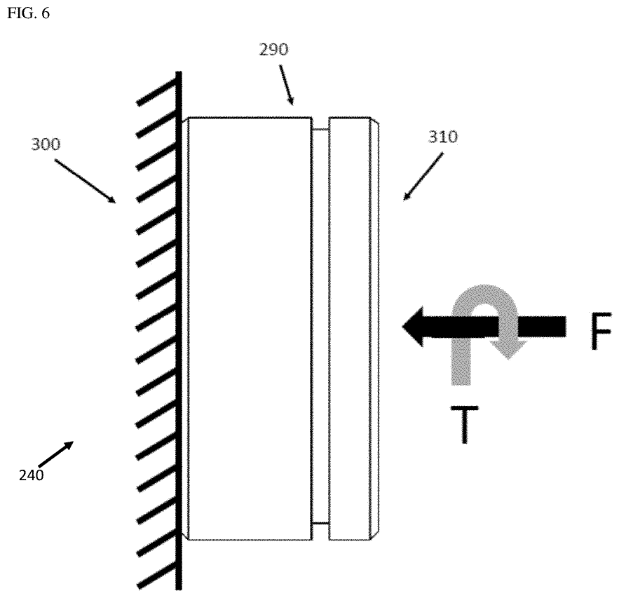

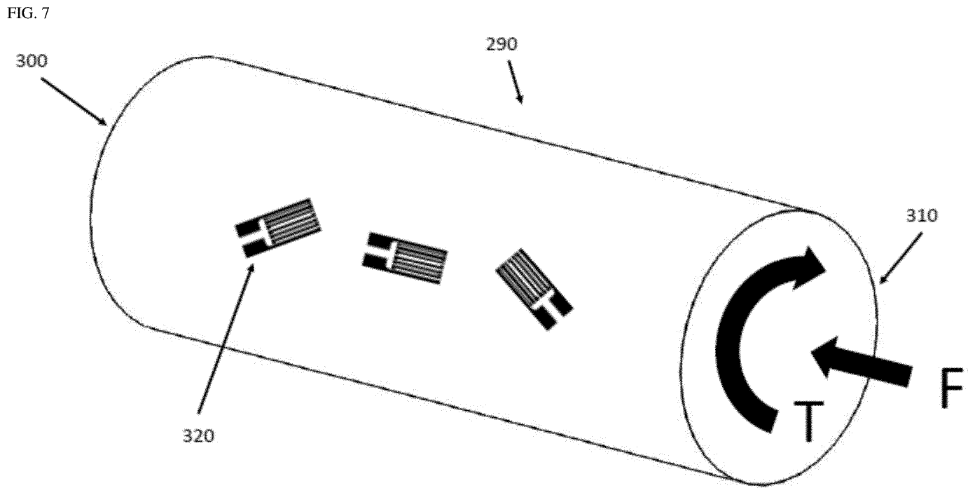

The shaft mount 210 is attached to one side of the reaction torque/force sensor 290 by means of shaft mount screws 240 as shown in FIG. 5. The reaction torque/force sensor 240 measures the reaction torque and force applied to the sensor 240 by taking the difference of torque and forces between a fixed side 300 and a floating side 310 wherein the force and torque is attached to the floating side 310 as shown in FIG. 6. The reaction torque/force sensor 240 consists of a plurality of strain gauges 320 in order to output the reaction torque and forces into an electrical signal as shown in FIG. 7.

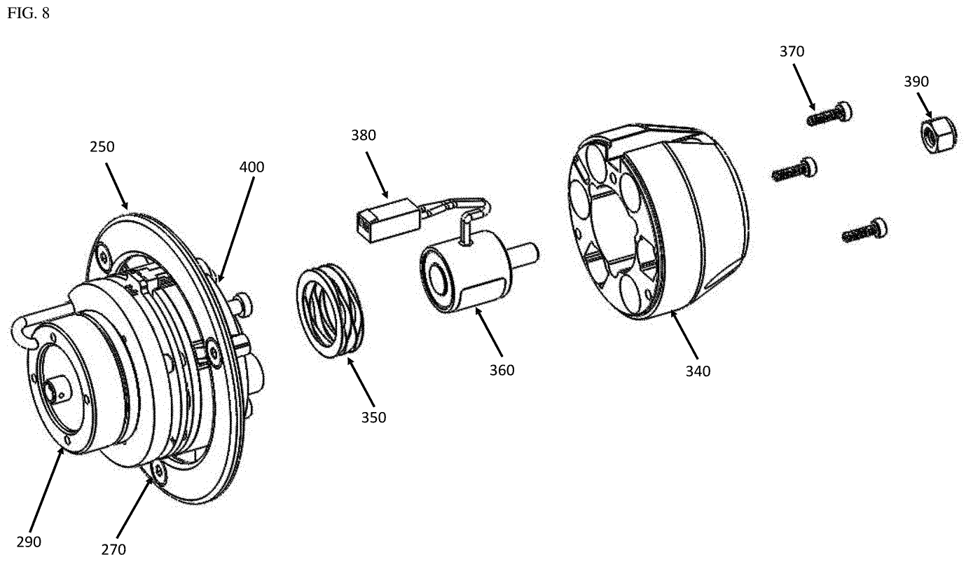

In the drawing FIG. 8, the solenoid mount 340 is attached to the main body 400 by means of the solenoid mount mounting screws 370. The permanent magnet holding solenoid 360 is attached to the solenoid mount 340 by means of the solenoid holding nut 390. The preload spring 350 is place over the permanent magnet holding solenoid 360 and is compressed between the solenoid mount 340 and the armature 410. The permanent magnet holding solenoid 360 is connected to the controller board 700 by means of a connector 380.

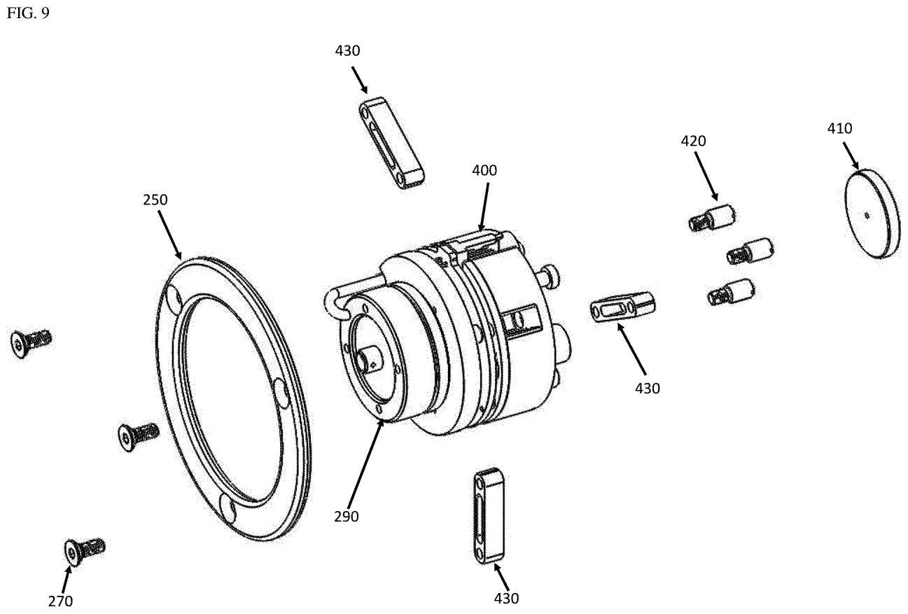

In the drawing FIG. 9, the armature 410 is connected to the release pin 620 by means of a thread on the release pin 620. The reset shafts 420 are connected to the reset arms 430 through the main body 400 by means of a thread on the reset shafts 420. The reset ring 250 is attached to the reset arms 430 by means of the reset ring mount screw 270.

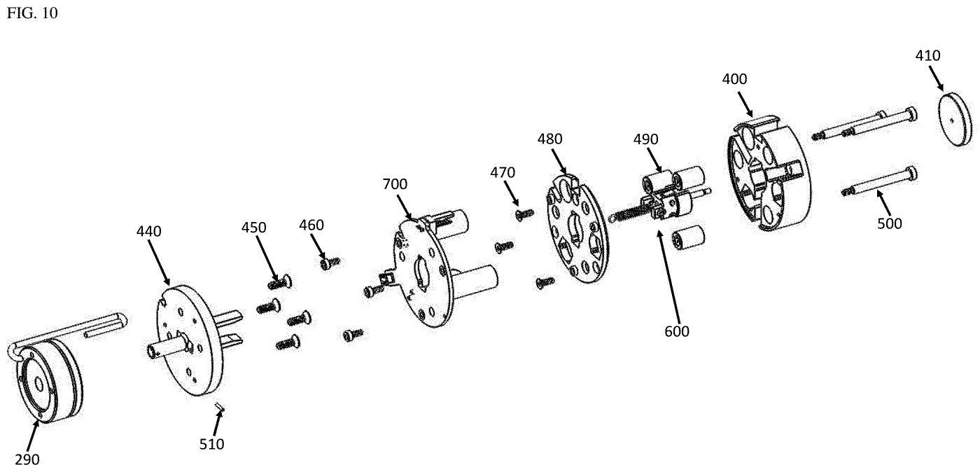

In drawing FIG. 10, the linear bearings 490 and pivot block assembly 600 and held in place between the main body 400 and the cap 480. The cap 480 is attached to the main body 400 by means of the cap mounting screws 470. The controller board 700 is attached to the cap 480 by means of the controller board mounting screws 470. The reaction torque/force sensor 290 is attached to the slide lock 440 by means of the slide lock mounting screws 450. The linear shafts 500 are placed through the linear bearings 490 and attached to the slide lock 440 by means of a thread on the linear shafts 500. The extension spring 610 is attached to the slide lock 440 by means of the extension spring locking pin 510 through the slide lock 440.

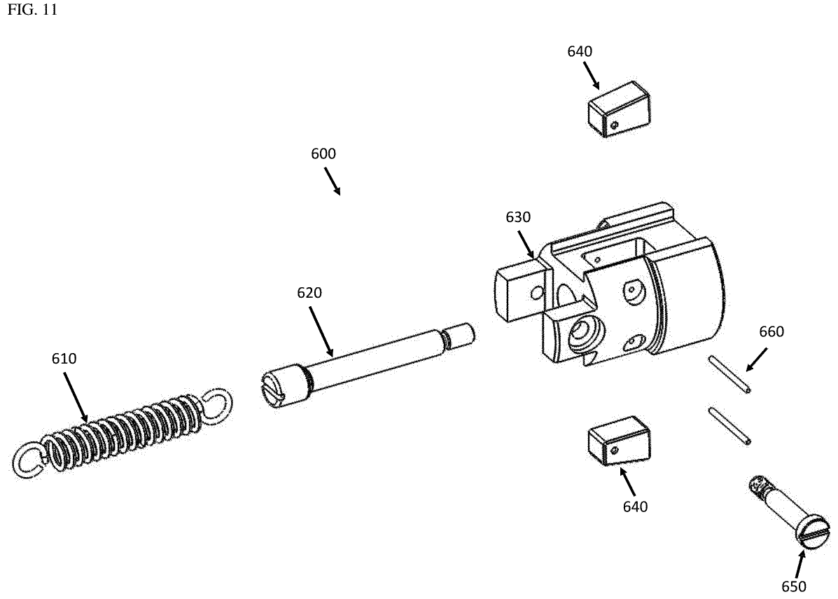

In drawing FIG. 11, the release pin 620 is placed into the pivot block mount 630 axially. The extension spring 610 is attached to the pivot block mount 630 by means of the extension spring locking screw 650. The pivot blocks 640 are attached to the pivot block mount 630 by means of the pivot block pins 660.

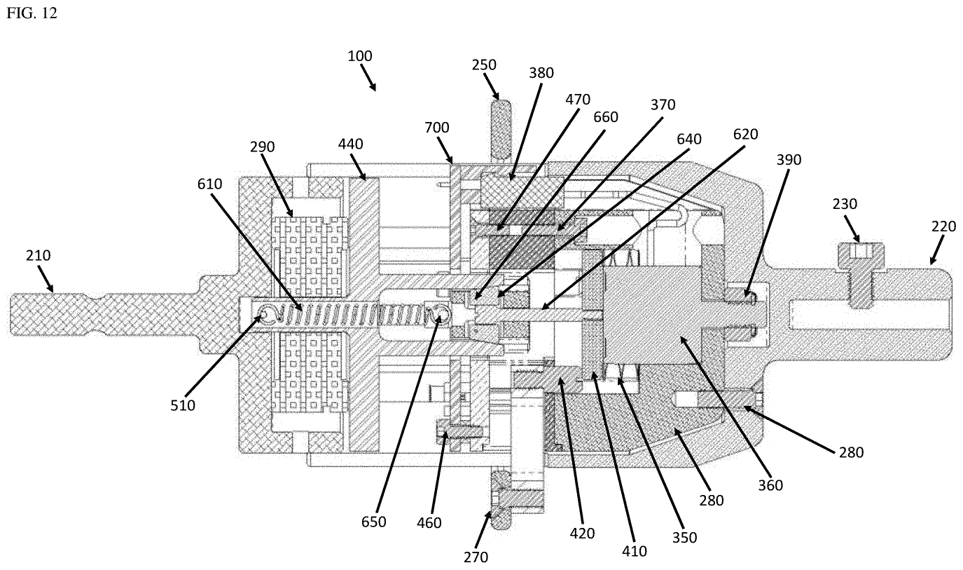

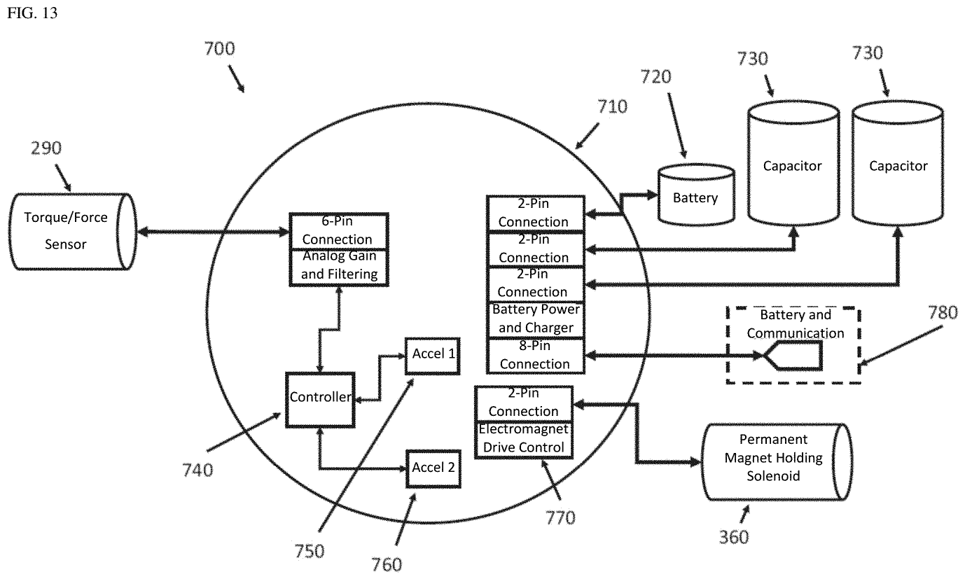

The retractable drill chuck system 100 starts operation in the “Extended/Locked” position as shown in FIG. 12. The armature 410 is held in place to the permanent magnet holding solenoid 360 without any electrical power applied to the permanent magnet holding solenoid 360, which in turn, compresses the preload spring 350 between the armature 410 and the solenoid mount 280. The slide lock 440 is locked into position by the pivot blocks 640 with a preload force applied from the extension spring 610. The pivot blocks 640 are unable to rotate as the release pin 620 is pulled into position by the armature 410. The retractable drill chuck system 100 begins to activate once the drill 110 rotates the retractable drill chuck system 100 and begins drilling through a material by means of the drill bit 120. The controller board 700 detects the movement of the retractable drill chuck system 100 with on board accelerometers 750 and 760 on the circuit board 710 connected to the controller 740 as shown in FIG. 13. As the retractable drill chuck system 100 begins to spin, the controller 740 measures the accelerometers 750 and 760 radial g-force and converts the values into a rotational speed. The controller 740 also begins to read the force and torque values from the reaction torque/force sensor 290. The controller 740 inputs these values into a neural network algorithm in order to track when the drill bit 120 has started to break through the material. Once the initial breakthrough event has been detected, the controller 740 activates solenoid drive control 770, in which the battery 720 and capacitors 730 drive enough current into the permanent magnet holding solenoid 360 to release the armature 410. The battery 720 is charged by an external connection 780. The controller 740 is programmed through an external connector 780.

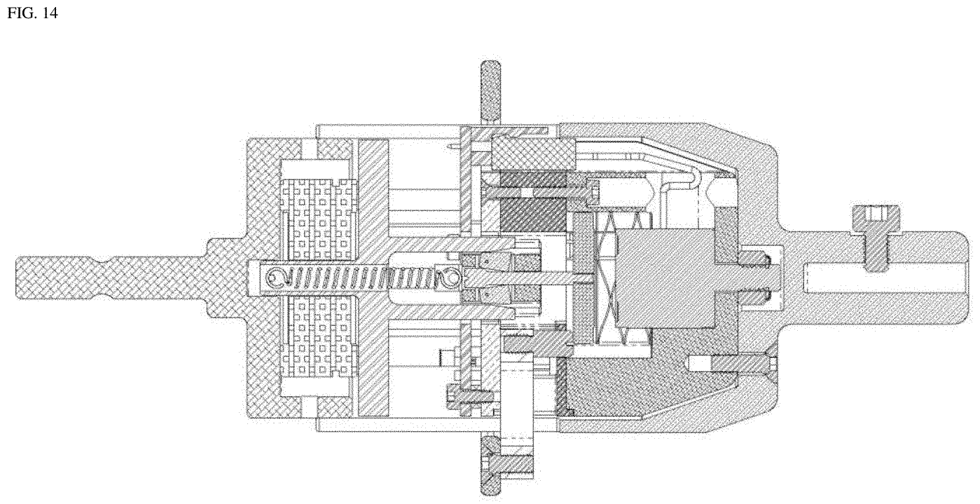

Once the armature 410 has been released from the permanent magnet holding solenoid 360, the armature 410 and release pin 620 are pushed towards the slide lock 440 by means of the preload spring 350 and sets the retractable drill chuck system 100 into the “Extended/Unlocked” position as shown in FIG. 14. The pivot blocks 640 are then able to rotate towards the release pin 620.

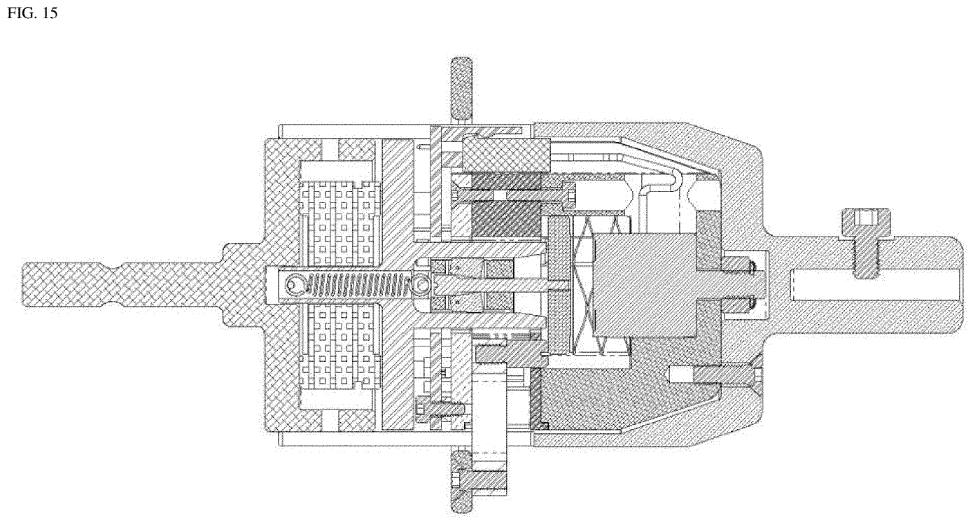

After the pivot blocks 640 move towards the release pin 620, the drill bit 120 is now free to move towards the slide lock 440 by means of the extension spring 610 and sets the retractable drill chuck system 100 into the “Retracted/Unlocked” position as shown in FIG. 15. The drill bit 120 moves in the axial direction due being rigidly attached to the drill bit mount 220 by means of the drill bit locking screw 230 and the drill bit mount 220 being rigidly mounted to the linear bearings 490 via the solenoid mount 280, main body 340 and cap 480 as well as the linear shafts 500 being constrained by the linear bearings 490.

Once the retraction has occurred, retractable drill chuck system 100 has to be reset back into the “Extended/Locked” position as shown in FIG. 12. This is completed by holding the drill 110 and pushing the reset ring 250 away from the drill 110. The reset ring 250 moves the armature 410, by means of the connected reset arm 260 and reset shafts 420. The pivot blocks 640 move past the slide lock 440 allowing the release pin 620 to pass under the pivot blocks 640. The armature 410 then reattaches to the permanent magnet holding solenoid 360 by means of magnetism.

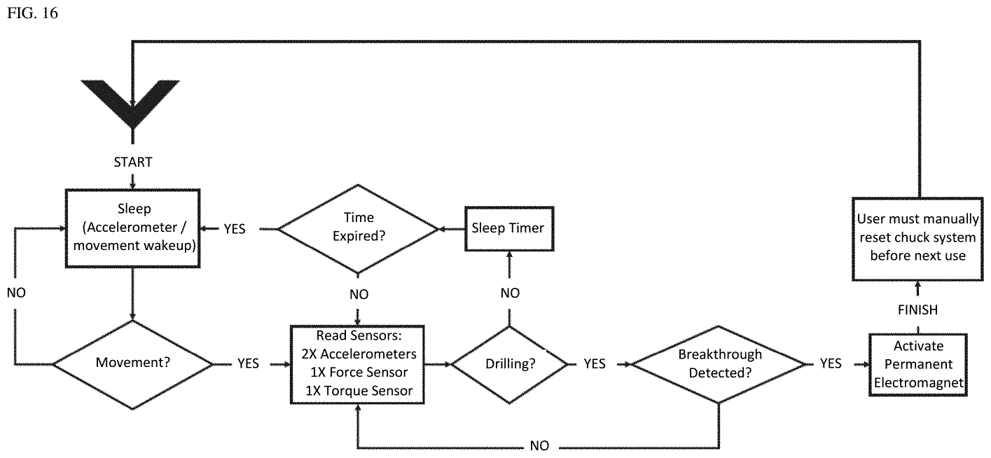

A flowchart can be used to show a method of operating a retractable drill chuck system according to an embodiment as shown in FIG. 16.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A drill chuck system capable of detecting a breakthrough event of a drill bit, the drill chuck system comprising:
a. one or more reaction torque sensors wherein the fixed side is attached to the drill side of the device and wherein the floating side is attached to the drill bit side of the device;
b. one or more reaction force sensors wherein the fixed side is attached to the drill side of the device and wherein the floating side is attached to the drill bit side of the device;
c. one or more accelerometer(s) are offset from the center of the device;
d. one or more batterie(s) are used to power the device;
e. one or more controllers are used to read the force, torque and acceleration sensor(s) and determine the drill bit breakthrough event;
f. a shaft mount to attach to a drill and/or rotating spindle; and
g. a drill bit holder.

2. The chuck system as in claim 1, further comprising:
a. one or more permanent magnet holding solenoid are used in the retraction mechanism of the device;
b. one or more set of linear bearing(s) and linear shaft(s) are used in the retraction mechanism of the device;
c. one or more slide lock(s) are used to control the locking of the retraction mechanism;
d. one or more pivot block(s) are used to control the locking of the retraction mechanism;
e. one or more release pin(s) are used to lock the pivot block(s) in place;
f. one or more armature(s) are used to attach to the permanent magnet holding solenoid(s) by means of magnetism;
g. one or more preload spring(s) are used to apply force to the armature(s);
h. one or more extension spring(s) are used to apply force to retract the drill bit; and
i. one or more capacitor(s) are used to activate the permanent magnet holding solenoid(s).

3. The drill chuck system as in claim 2, further comprising one or more electromagnet actuator and/or solenoid actuator that are used in place of the permanent magnet holding solenoid(s) and armature(s).

4. The drill chuck system as in claim 3, further comprising one or more bushings that are used in the retraction mechanism in place of the linear bearing(s).

5. The drill chuck system as in claim 2, further comprising one or more bushings that are used in the retraction mechanism in place of the linear bearing(s).

6. The drill chuck system as in claim 1, wherein one controller is used to determine the drill bit breakthrough event detection and control the retraction mechanism activation.

7. The drill chuck system as in claim 2, wherein one controller is used to determine the drill bit breakthrough event detection and control the retraction mechanism activation.

8. The drill chuck system as in claim 1, wherein one controller is used to read the force, torque, and acceleration sensor(s), determine the drill bit breakthrough event, and control the retraction mechanism activation.

9. The drill chuck system as in claim 2, wherein one controller is used to read the force, torque, and acceleration sensor(s), determine the drill bit breakthrough event, and control the retraction mechanism activation.

10. The drill chuck system as in claim 1, further comprising one or more gyroscopes that are used in the breakthrough event detection system.

11. The drill chuck system as in claim 2, further comprising one or more gyroscopes that are used in the breakthrough event detection system.

12. The drill chuck system as in claim 1, further comprising one or more gyroscopes that are used in the breakthrough event detection system in place of the accelerometer(s).

13. The drill chuck system as in claim 2, further comprising one or more gyroscopes that are used in the breakthrough event detection system in place of the accelerometer(s).
